(19) United States
(12) Patent Application Publication
(10) Pub. No.: US 2009/0071557 A1
(43) Pub. Date: Mar. 19, 2009

(54) ROTARY CERAMIC CHIP OF A WATER CONTROL CERAMIC VALVE

(76) Inventor: Shao Pin PENG, Tanzih Township (TW)

Correspondence Address: EGBERT LAW OFFICES, 412 MAIN STREET, 7TH FLOOR, HOUSTON, TX, 77002, US

(21) Appl. No.: 11/855,055

(22) Filed: Sep. 13, 2007

(51) Int. Cl. F16K 11/074

(52) U.S. Cl. 137/607; 137/606; 137/625.21

(57) ABSTRACT

The present invention provides an improved rotary ceramic chip of a water control ceramic valve, which is used to address the problems arising from rapid linking or misalignment of the through-flow slot of a typical rotary ceramic chip and water inlet of fixed ceramic chip. The rotary ceramic chip is assembled between a braking element and fixed ceramic chip of the water control ceramic valve. At the bottom of the rotary ceramic chip, there is an upward recessing through-flow slot, which is provided with a first slot portion and a second slot portion. A bleed groove is placed laterally onto the second slot portion. When the second slot portion is linked to or misaligned with a water inlet of the fixed ceramic chip, the bleed groove enables slowdown or gradual change of the water pressure.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a water control ceramic valve, and more particularly to an innovative valve with a through-flow slot in the rotary ceramic chip.

2. Description of Related Art Including Information Disclosed Under 37 CFR 1.97 and 37 CFR 1.98.

The water control ceramic valve is primarily provided with rotary ceramic chip and a fixed ceramic chip. The rotary ceramic chip is overlapped over the fixed ceramic chip and can be shifted or rotated by the brake valve lever. So, a through-flow slot at a bottom of the rotary ceramic chip aligns with the water inlet and outlet of the fixed ceramic chip, thus controlling the switching of water flow and adjustment of water temperature. Moreover, the rotary and fixed ceramic chips present the advantages of strong resistance to high temperature and abrasion.

The present invention is intended to improve through-flow slot structure of said rotary ceramic chip. FIG. 1 depicts a through-flow slot 11 of typical rotary ceramic chip 10. Typically, the through-flow slot 11 is an elliptical slot. When the through-flow slot 11 is placed at a predefined location, both ends are allowed to link simultaneously cold/hot water inlets 21, 22 and water outlet 23 of the fixed ceramic chip 20, thereby guiding or starting/closing water flow.

However, there are shortcomings observed during actual applications. Since a typical through-flow slot 11 is generally an extended flat shape (e.g. straight line, curved line), the through-flow slot 11 is quickly linked to or misaligned with cold/hot water inlets 21, 22 (shown in FIG. 2) of fixed ceramic chip 20, leading to remarkable change of internal water pressure. The higher water pressure of the water supply pipeline, the bigger damage against water pipeline may occur. This is because instantaneous reaction pressure of through-flow slot arising from rapid switching of water flow may lead to rapid shrinkage or expansion of pipeline, so the pipeline materials are quickly degraded and cracked, and the linkage parts are loosened, resulting in shorter service life of water supply devices.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

The enhanced efficacy of the present invention is as follows:

Referring to FIGS. 3, 4 and 5, at least a bleed groove 32 is placed laterally onto the second slot portion 312 of the through-flow slot 31. So, when the second slot portion 312 of through-flow slot 31 is linked to or misaligned with cold/hot water inlets 52, 53 of the fixed ceramic chip 50, the bleed groove 32 enables slowdown or gradual change of the water pressure. So, some water flow pressure is firstly discharged to prevent direct impact of water flow on internal components of water control ceramic valve 40, or sharp expansion of pipe wall and possible crack due to inflow of water into the water pipe. As compared with prior art, the present invention can improve efficiently the problem of sharp change of water pressure, further protecting water control ceramic valve 40 and relevant water supply pipelines and extending the service life.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of the operation of a typical prior art rotary ceramic chip.

FIG. 2 shows another schematic view of the operation of a prior art rotary ceramic chip.

FIG. 3 shows an exploded perspective view of a rotary ceramic chip and water control ceramic valve of the present invention.

FIG. 4 shows an upper schematic view of a rotary ceramic chip of the present invention.

FIG. 5 shows a vertical sectional view of a rotary ceramic chip of the present invention.

FIG. 6 shows an assembled sectional view of a rotary ceramic chip and water control ceramic valve of the present invention.

FIG. 7 shows a schematic view of the operation of a rotary ceramic chip of the present invention.

FIG. 8 shows another schematic view of the operation a rotary ceramic chip of the present invention.

FIG. 9 shows a third schematic view of the operation of a rotary ceramic chip of the present invention.

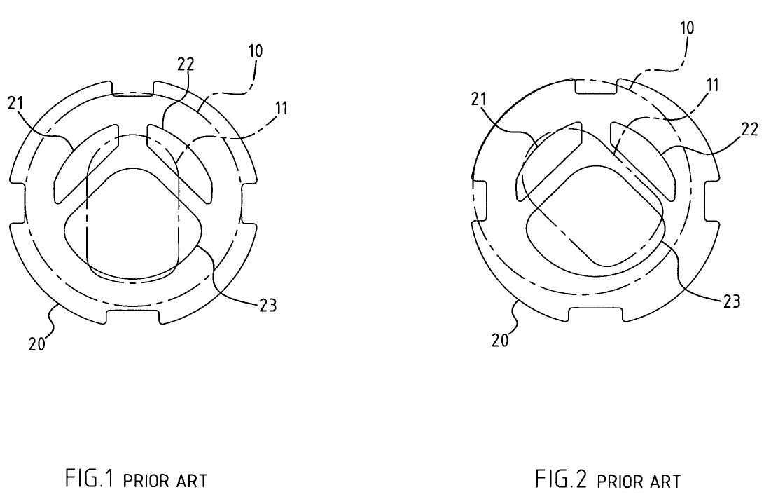

### DETAILED DESCRIPTION OF THE INVENTION

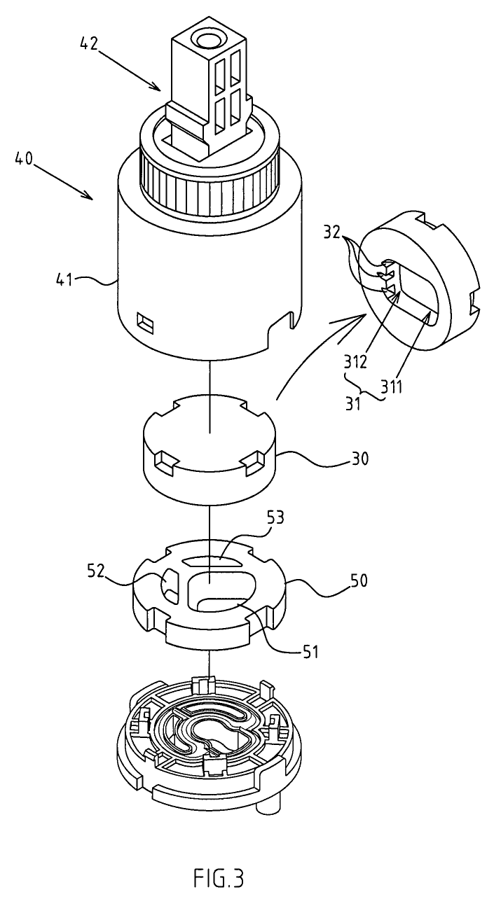

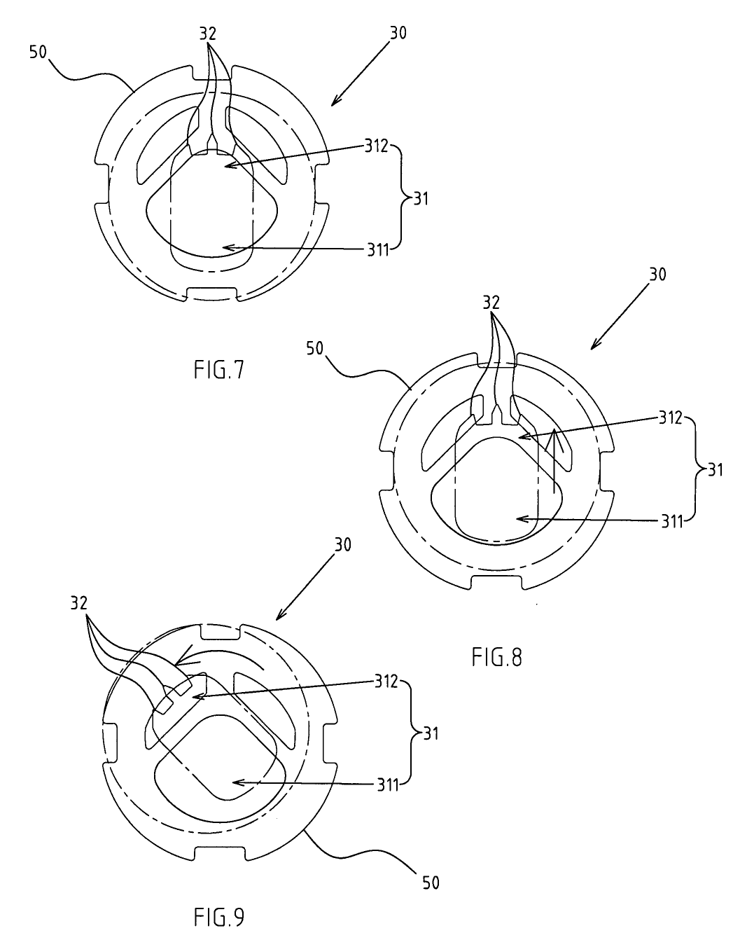

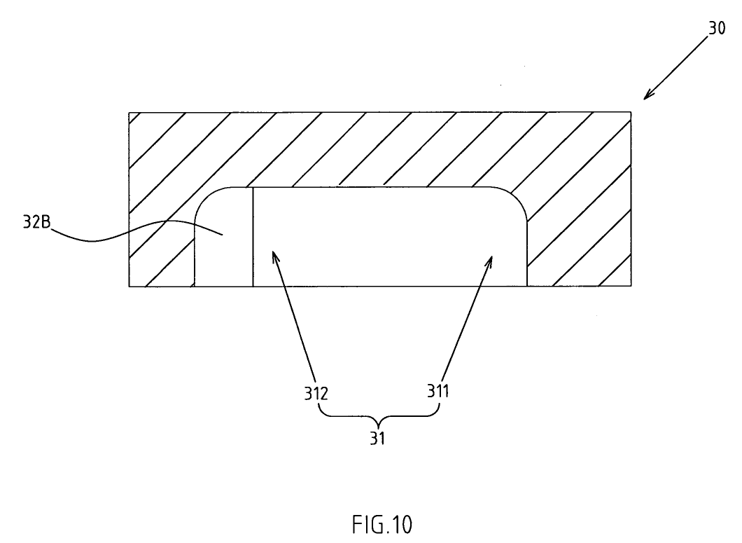

FIGS. 3-9 depict preferred embodiments of an improved rotary ceramic chip (1) of a water control ceramic valve of the present invention. The embodiment are provided for only explanatory purposes. The scope of the invention is set by the patent claims.

Referring to FIG. 3, the rotary ceramic chip 30 of the present invention is assembled between braking element 42 and fixed ceramic chip 50 within the housing 41 of water control ceramic valve 40. At the bottom of the rotary ceramic chip 30, there is an upward recessing through-flow slot 31. The first slot portion 311 of the through-flow slot 31 is linked to the water outlet 51 of fixed ceramic chip 50, and the second slot portion 312 of the through-flow slot 31 is linked to cold/hot water inlets 52, 53 of the fixed ceramic chip 50. Moreover, at least a bleed groove 32 is placed laterally onto the second slot portion 312 (three bleed grooves 32 available for the second slot portion 312 in this figure).

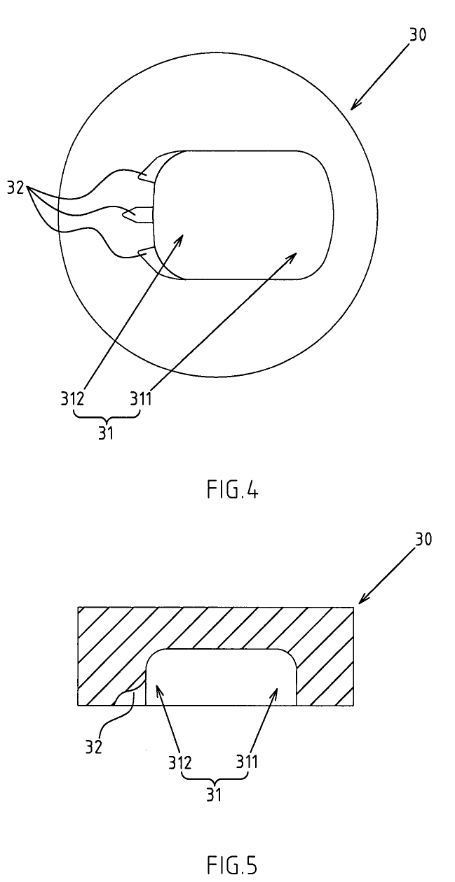

FIGS. 4 and 5 depict a pyramidal cross section of said bleed groove 32.

Based upon above-specified structures, the present invention operates as follows.

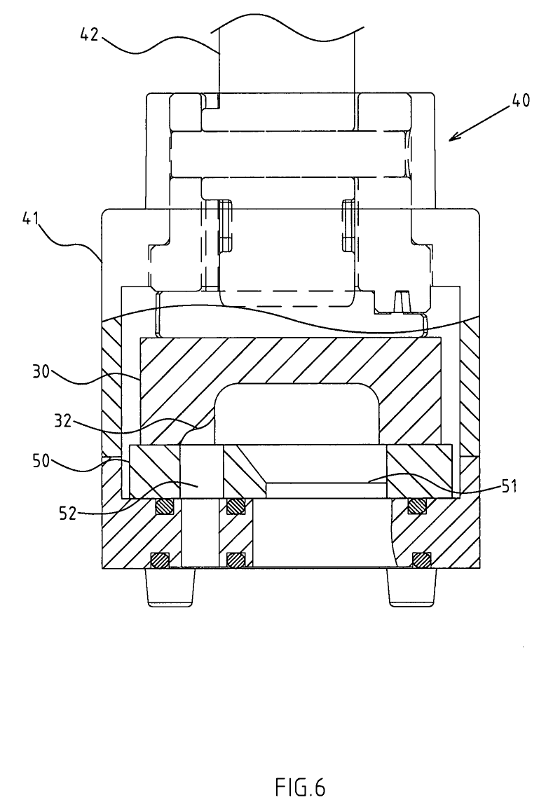

Referring to FIGS. 6, 7, 8 and 9, when the braking element 42 is operated, the rotary ceramic chip 30 is driven by components within the water control ceramic valve 40. In such a case, the rotary ceramic chip 30 is driven to shift towards cold/hot water inlets 52, 53 of the fixed ceramic chip 50. When the pyramidal cross section of said bleed groove 32 of second slot portion 312 is partially overlapped with cold/hot water inlets 52, 53 of the fixed ceramic chip 50, a portion of water flow is discharged from the overlapped part to through-flow slot 31, and then to water pipeline from water outlet 51 for pressure reduction.

When the rotary ceramic chip 30 is driven to shift from cold water inlet 52 to hot water inlet 53 of the fixed ceramic chip 50, the bleed groove 32 is arranged in such a manner that some hot water is mixed with cold water to avoid adverse influence upon the valve elements.

Additionally, when the rotary ceramic chip 30 is driven by braking element 42 to shift towards hot water inlet 52, and when hot water flows from the second slot portion 312 of through-flow slot 32 to the first slot portion 311, the bleed groove 32 is arranged in such a manner that some hot water is discharged and then guided to the water pipe from water outlet 51. Possible damage to internal components arising from excessive inflow of hot water into water control ceramic valve 40 is avoided.

FIG. 10 depicts another preferred embodiment of the present invention, of which the bleed groove 32B is arranged into an arched profile.

1. A rotary ceramic chip of a water control ceramic valve, being assembled between a braking element and a fixed ceramic chip within a housing of said water control ceramic valve, said rotary ceramic chip comprising:
an upward recessing through-flow slot at a bottom thereof, the slot having a first slot portion linked to a water outlet of the said fixed ceramic chip and a second slot portion linked to cold/hot water inlets of said fixed ceramic chip; and
a bleed groove placed laterally onto said second slot portion of the through-flow slot.

2. The chip defined in claim 1, wherein said bleed groove has a pyramidal cross section.
